(19) United States
(12) Patent Application Publication
(10) Pub. No.: US 2008/0310096 A1
(43) Pub. Date: Dec. 18, 2008

(54) Invention that protects digital data stored on a computer system from fire and water

(76) Inventors: Samir Gajendra Sandesara, Sacramento, CA (US); Lawrence Joseph Henry, Sacramento, CA (US)

Correspondence Address: The Law Office of Joseph H. Marman;Suite #145, 8421 Auburn Blvd., Citrus Heights, CA, 95610, US

(21) Appl. No.: 12/152,937

(22) Filed: May 19, 2008

Related U.S. Application Data
(60) Provisional application No. 60/934,169, filed on Jun. 12, 2007.

(51) Int. Cl. G06F 1/16

(52) U.S. Cl. 361/685; 361/684

(57) ABSTRACT

The invention herein protects digital computer data from physical natural disasters such as fire and flood. While most methods of data backup to combat these threats rely on physical separation of the data and main computer system, this invention can be used inside the main physical computer and thus provide intervention-free data protection from environmental hazards. When implemented for use inside a computer, the invention adheres to industry standard specifications for size and electrical interfaces. This ensures maximum compatibility with the existing industry infrastructure; custom shapes, sizes, and interfaces would inherently be supported by the invention. Furthermore, the invention can replace the physical casing used by data storage devices. For example, the invention could replace the physical aluminum base casting of a desktop 3.5″ hard disk drive. Alternatively, the invention can be used as a protective jacket to envelop a mobile 2.5″ hard drive with a jacket dimensioned for 3.5″ desktop hard drives.

### CROSS-REFERENCE TO RELATED APPLICATIONS

This application claims benefit of and priority from U.S. Provisional application 60/934,169 filed on Jun. 11, 2007

### FEDERALLY SPONSORED RESEARCH OR DEVELOPMENT

Not Applicable

### BACKGROUND OF INVENTION

Home users and businesses are storing ever increasing amounts of data on computers. This trend has been supported by the exponentially increasing hard disk capacity along with the exponentially decreasing cost of storage over the last decade. There is a downside to this trend however; storing more information on an individual drive also means a substantially increased impact when of data loss occurs.

For businesses, the information on a hard drive typically represents a highly valuable knowledge archive and future corporate IP. The Computer Security Institute values the information contained on a single hard drive at over $36,000. However, the true loss is considerably higher when considering business resources spent trying to recover/rebuild the lost information.

For home users, the information on a hard drive represents not only personal financial details and contact information, but also represents irreplaceable personal memories in the form of e-mails, photographs and movies. As such, it's evident, that the information on computers is worth far more than the physical computer itself.

Given the value of their data, the majority of computer users, businesses and individuals recognize the importance of performing routine data backups. Many even invest in external storage devices for active backup with minimal user intervention. However, unless these backups are stored in a geographically remote location, they only mitigate loss from hardware failure and theft; not from natural disaster. Furthermore, they all consume additional physical space. External storage devices require an added footprint near the main system. Removable storage backups (such as CDs, DVDs, and USB flash drives) can be stored away from the main system but these too consume additional space. Securing these external backup strategies against natural disasters is possible through the use of data-safes which adhere to specifications such as UL-72. However, these typically require even more physical space, and also result in backups that are only as current as the user is disciplined. Insuring that the data protected is current and relevant requires protecting the data at the location it is being generated; a shortcoming none of the existing widely used backup methods address.

### BRIEF SUMMARY OF THE INVENTION

The preferred embodiment of this invention provides a protective case around the data carrying media in a hard disk drive. The data carrying media portion of the hard disk drive specifically are the components that provide non-volatile memory using magnetic, optical, or electrical methods. These components can be either moving or non-moving depending on their specific implementation. The casing around the data carrying media is designed to protect the stored data from physical natural disasters such as fire and flood. Furthermore, the casing conforms to industry standard form factors for storage devices in desktop and mobile computer systems.

As a result, the invention fits inside any standard computer system. Thus the invention provides protection from natural disasters without needing any additional physical space outside of the computer system. Furthermore this protection is provided in real time, without the need for user generated backups. While the primary embodiment of this invention for use inside a computer system, it can inherently be used outside as well.

### BRIEF DESCRIPTION OF THE DRAWINGS

FIG. 1 and FIG. 2 illustrate one embodiment of the invention depicting its use as a protective jacket or sheath for an existing, readily available data storage device, enlarging the smaller form factor to mount into the retention mechanisms of a larger form factor.

FIG. 3, FIG. 4, FIG. 5, and FIG. 6 illustrate one embodiment of the invention depicting its use as a multi-piece assembly providing a protective replacement for the typically aluminum base casting.

FIG. 7 and FIG. 8 illustrate one method of construction of a mechanical device, a hard disk spindle, which needs to breach the primary cavity of a replacement base casting type application of the invention.

FIG. 9 is a representation of one embodiment of the series placement of thermal fuses which provide electrical connectivity across the protective barrier, and also provide thermal isolation in the presence of excessive heat.

FIG. 10 depicts one implementation of mounting reinforcement strips which will allow the invention, built primarily of non-metallic materials, to be mounted in industry standard form factor chassis with typical attach methods.

FIG. 11 depicts one implementation of a hydro-reactive barrier comprised of layered composite materials, which in normal conditions allow pressure equalization and air exchange between the inner cavity and the external atmosphere, and while in the presence of excessive heat or water forms an impenetrable barrier sealing the breather hole or voids left by thermal fuses.

### DETAILED DESCRIPTION OF THE DRAWINGS

The features of the invention will be better understood by reference to the accompanying drawings which illustrate potential embodiments of the invention. In the drawings:

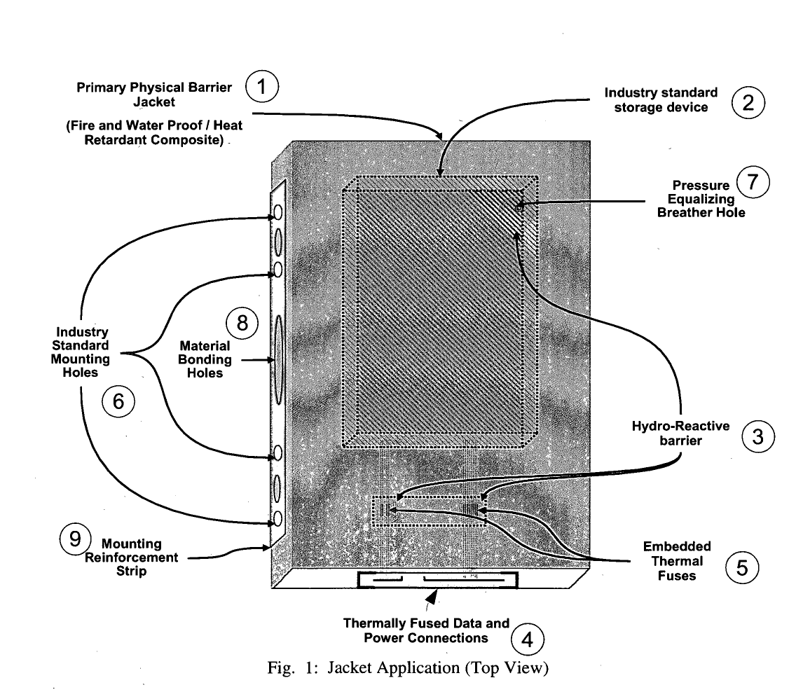

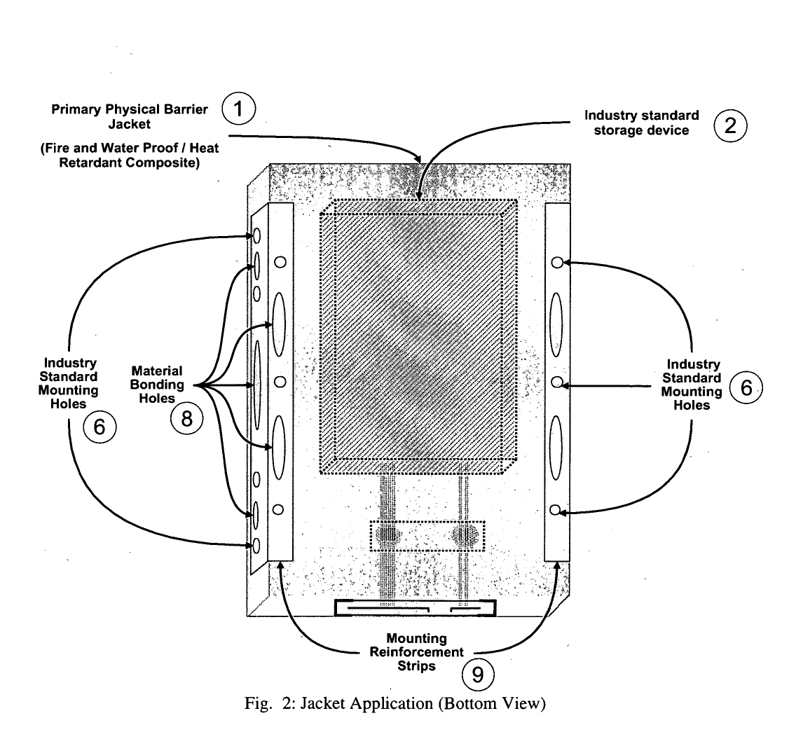

FIG. 1 and FIG. 2 depict a typical jacket type application of the invention as it would apply to an internal hard drive. An industry standard storage device 2 is placed within the jacket allowing its use with “commercial off the shelf” products. The jacket has molded into it mounting reinforcement strips 9 which provide industry standard mounting holes 6 allowing for its use with the existing retention mechanisms within a standard computer system chassis. It is evident that any storage device can be embedded into the barrier jacket and also that this approach can be modified for external use.

The primary physical barrier 1 constitutes the majority of the material in the application and is fully molded around all the internal components and through the material bonding holes 8 of the mounting reinforcement strips 9. Furthermore, the embedding of thermal fuses 5 into the primary physical barrier permits safe exposure of data and power carrying connections 4 to the external environment. A hydro-reactive barrier 3 provides protection from water seepage or heated air penetration for any void left by blown fuses. This same hydro-reactive barrier is also shown used behind the pressure equalizing breather hole 7 on the primary physical barrier. This hole extends functionality of the breather hole found on most modern hard disk drives as well as providing ventilation for the storage device enclosed within.

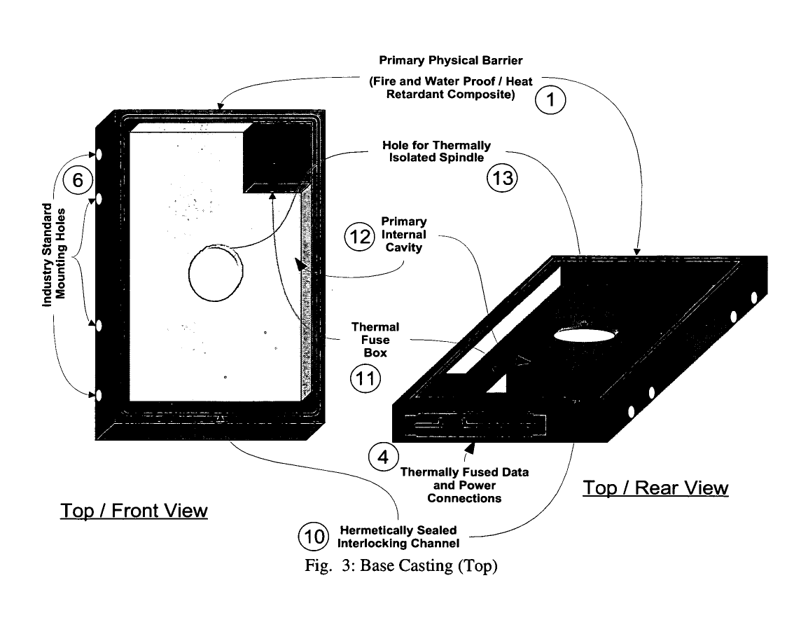

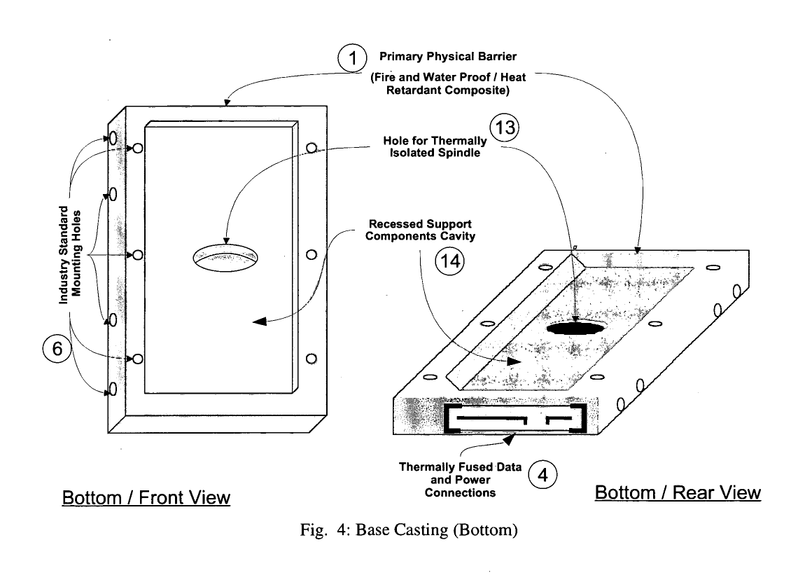

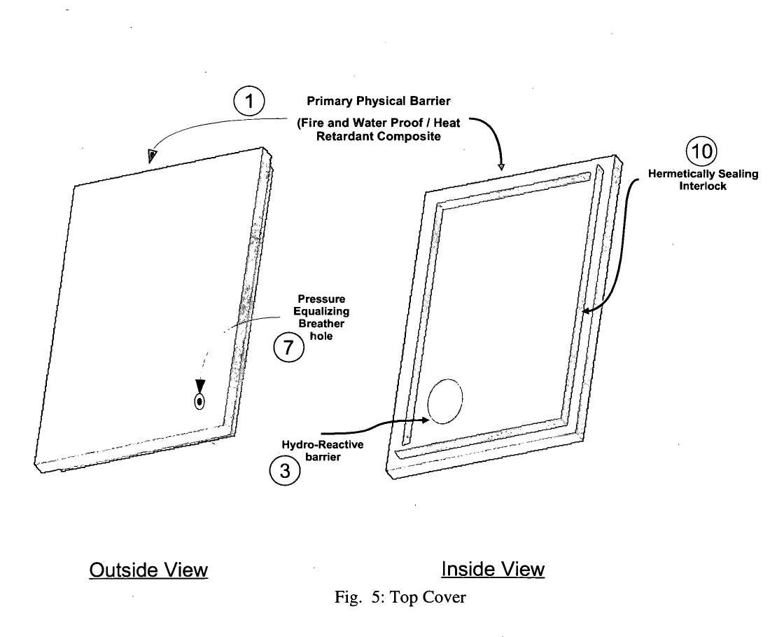

FIG. 3, FIG. 4, FIG. 5, and FIG. 6 depict an application where the base casting and cover of an existing hard drive are made out of the primary physical barrier 1 instead of typical metals such as aluminum and steel. In this application, industry standard holes 6 are integrated into the base casting providing physical interoperability with existing computer chassis. The top and bottom pieces can geometrically fit together using an interlocking channel 10 providing a hermetic seal. The thermal fuses are shown placed in a dedicated thermal fuse box 11 and provide a protected path for external power and data connections 4 from the outside into the primary internal cavity 12. These thermal fuses can also provide protected connections for any signals that need to enter the primary internal cavity 12 for communication and control electronics from the external recessed support components cavity 14. A hydro-reactive barrier 3 provides protection from water and heated air intrusion through the breather hole 7. As the application depicted would need to accommodate a thermally isolated spindle to rotate the data storage platters, a passageway 13 is provided for the mechanical surfaces that need to come in contact with the data storage media within the primary internal cavity 12.

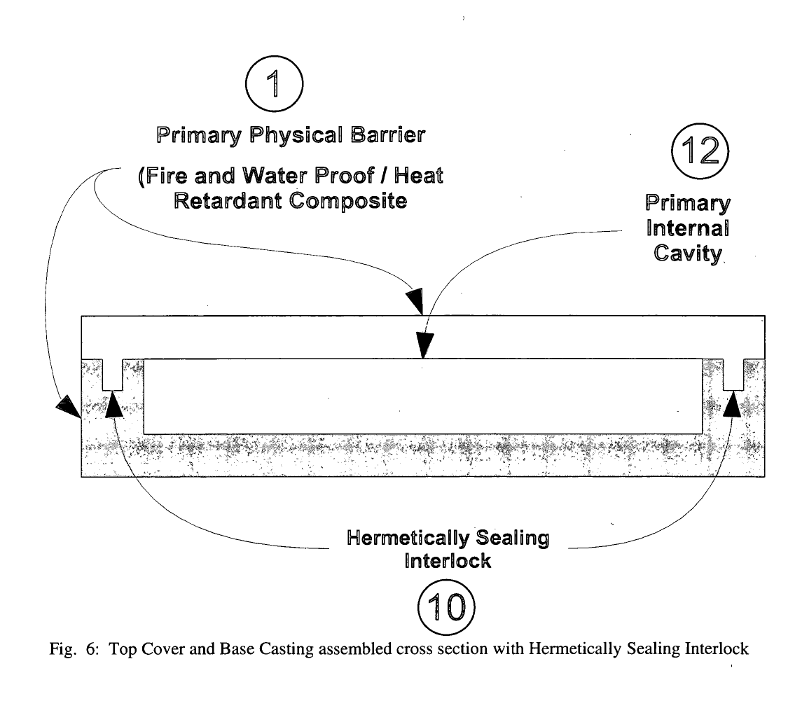

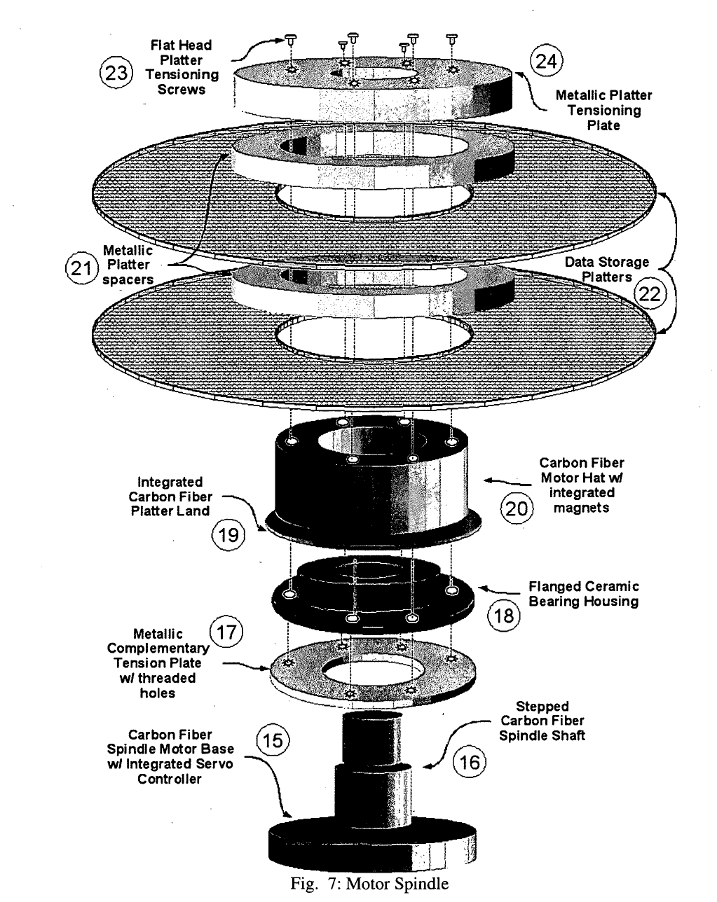

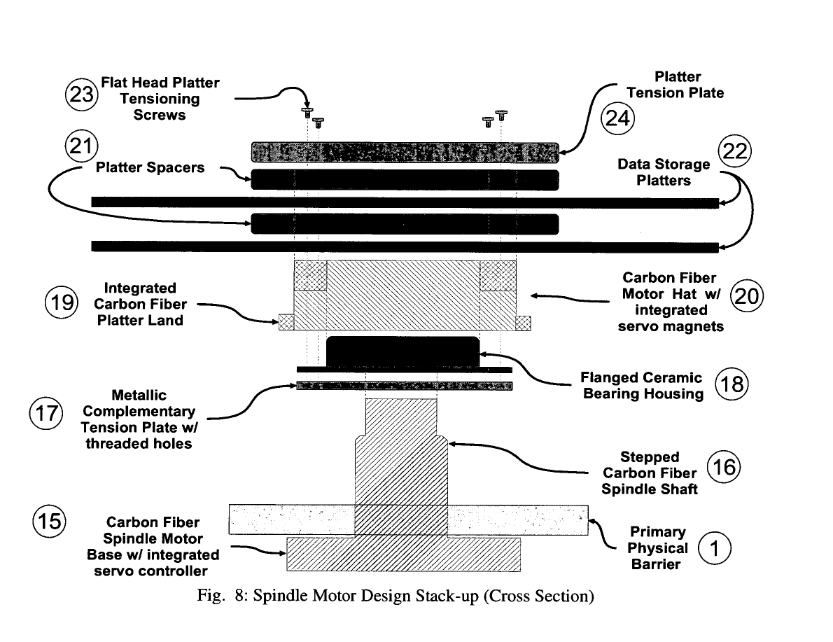

FIG. 7. and FIG. 8 depict the assembly of a mechanical device, such as a hard disk drive spindle, that needs to extend through the primary physical barrier 1 from the exterior surfaces of a device such as that shown in FIG. 3, FIG. 4, and FIG. 5. All parts of the spindle that can provide a path of thermal conductivity from the exterior of the case to the data storage platters 22, such as the spindle motor base 15, shaft 16, motor hat 20, and platter land 19 are constructed out of materials with minimal thermal conductivity such as carbon fiber. Typical heat generating components of the motor assembly, such as the bearings 18, are constructed of materials such as ceramics which exhibit low coefficients of friction, and thereby generate minimal thermal build up at high rotational speeds, allowing for their use inside the primary internal cavity 12 without significant internal thermal rise therein. A single set of flat head screws 23 is used to bind and retain all components in the assembly through the use of tension. Tension is generated by the force of the flat head screws 23 pulling a tensioning plate 24 and a complementary tension plate 17 together. Precise arrangement of the data storage platters 22 while under tension is maintained by use of metallic plater spacers 21 and a platter land 19 integrated onto the motor hat 20. The complementary tension plate 17 also serves to provide structural rigidity to the platter land 19 when under tension. Affixing the complete tensioned assembly to the spindle shaft 16 is achieved by geometric press-fitting of the bearing 18 onto the narrower of the spindle shaft 16.

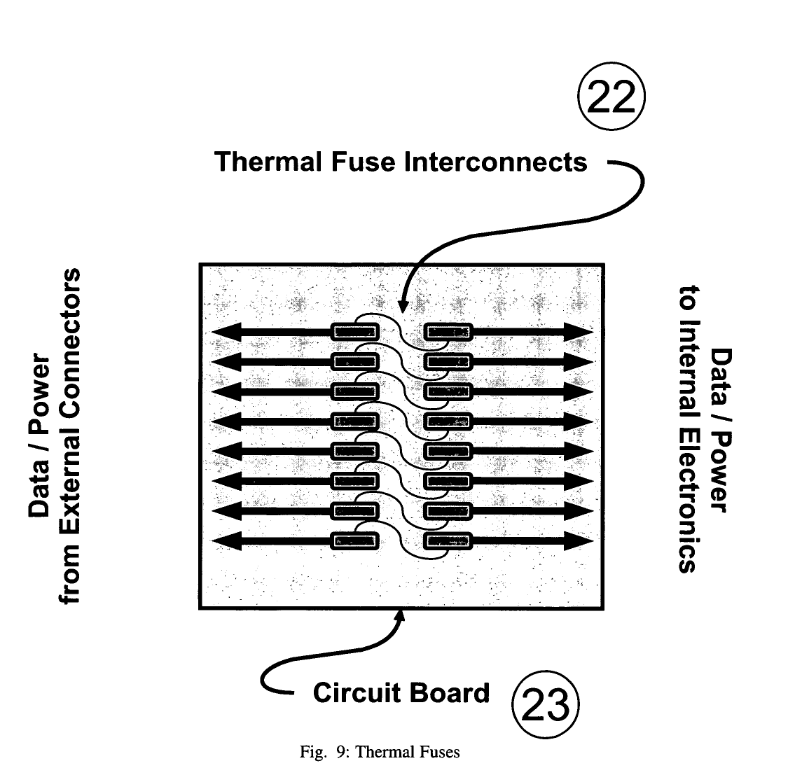

FIG. 9 illustrates the use of thermal fuses 22 to isolate electrical signals from the outside environment in the event of a fire. The fuse carrying circuit board 23 is placed in series with the electrical connections and embedded appropriately for jacket or base casting applications. This serial placement of the fuses allows them to ensure isolation if excessive heat is transferred through the wires connected to the external data and power connectors 4.

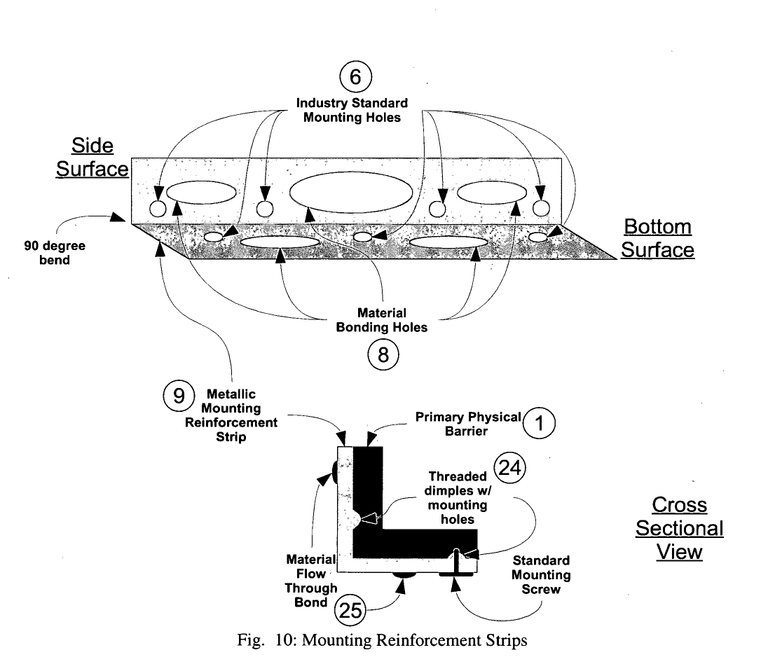

FIG. 10 depicts a method of implementing mounting points compatible with standard chassis attach methods on embodiments of the invention. The metallic mounting reinforcement strip 9 provides industry standard holes 6 that can accept typical steel mounting screws. The mounting holes are provided in threaded dimples 24. These dimples provide lateral support once the strip has been attached to the edge of the protective device. The strip is attached to the nonmetallic device by means of material flow holes 8. These holes allow the strip to be permanently molded into the primary physical barrier 1 during manufacturing by allowing some of the primary barrier material to pass through them. Once the material dries, a mechanical bond is formed 25 and the mounting strip is permanently attached.

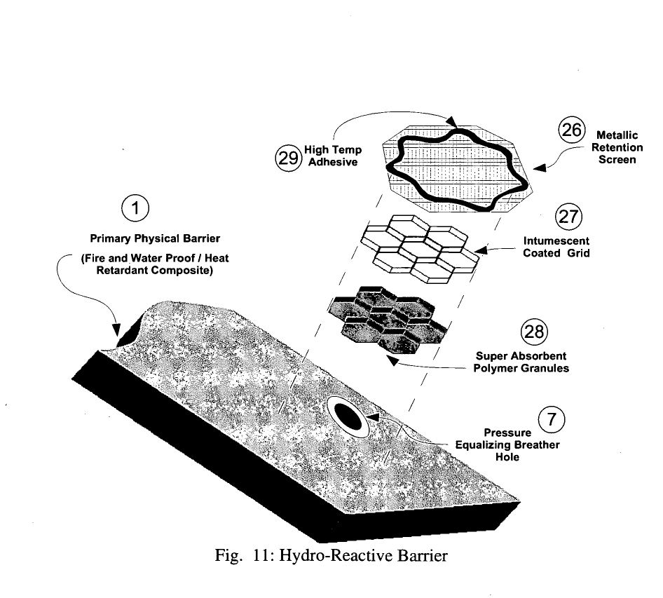

FIG. 11 depicts a method of assembling a hydro-reactive barrier to prevent water and heated air from penetrating the primary physical barrier 1 through voids left by blown thermal fuses, or the pressure equalizing breather hole 7. Super absorbent polymer granules 28 absorb water and form a single solid barrier to prevent water seepage. A grid coated with an intumescent material 27 will char and form an insulating barrier halting the infiltration of damaging heated air. These barriers are held in place with a metallic retention screen which is affixed around the hole to be protected by use of a high temperature adhesive 29.

Many variations of the invention will occur to those skilled in the art. Some variations include adapting the invention for use with storage devices utilizing solid-state “flash” memory. Other variations include utilizing the device externally from the main computer system. As industry standard form factors for internal data storage devices are adhered to, all such variations are intended to be within the scope and spirit of the invention.

Although some embodiments are shown to include certain features, the applicant(s) specifically contemplate that any feature disclosed herein may be used together or in combination with any other feature on any embodiment of the invention. It is also contemplated that any feature may be specifically excluded from any embodiment of an invention. The scope of the invention is to be defined by the following claims.

1. Device for protecting an internal computer data storage device from data loss due to environmental factors comprising:
a mechanically passive protective sheath of composite materials fully formed around an industry standard data storage device;
wherein said protective sheath's external dimensions conform to industry standard form factors for internal computer storage devices;
wherein said protective sheath contains an internal cavity with dimensions which conform to industry standard form factors for internal computer storage devices;
wherein said protective sheath forms an external open cavity of negative depth to house external electrical power and data connections.
wherein said protective sheath contains embedded thermal fuses connecting the internal cavity to the exterior surface for aforementioned power and data connections;
multiple mounting reinforcement strips providing multiple mounting holes in industry standard positions around aforementioned protective sheath for mechanical compatibility with standard retention mechanisms for internal computer storage devices;
a pressure equalizing breather hole providing venting capabilities for the aforementioned internal cavity through said protective sheath;
multiple hydro-reactive barriers providing isolation from water and heated air through which aforementioned thermal fuses and breather hole pass.

2. The device of claim 1, wherein said data storage device includes hard disk drives, solid-state hard drives, optical disk drives, tape drives, and holographic storage devices.

3. The device of claim 2, wherein the data storage device to be protected is sealed within the aforementioned protective sheath.

4. The device of claim 1, wherein said environmental factors include fire and water.

5. The device of claim 1, wherein said composite materials provide low thermal conductivity, high flame retardation, and zero water absorption.

6. The device of claim 1, wherein said industry standard dimensions include industry standard 5.25 inch, slim 5.25 inch, 3.5 inch, 2.5 inch, slim 2.5 inch, and 1.8 inch form factors.

7. The device of claim 1, wherein said thermal fuses are non-resettable electrically conducting devices.

8. The device of claim 1, wherein said mounting reinforcement strips are permanently attached to aforementioned protective sheath during manufacture.

9. The device of claim 8, wherein said reinforcement strips are machined with mounting holes threaded with American 6-32 UNC 2B threads and located 3-4 along each length and 4-6 around the bottom perimeter.

10. The device of claim 9, wherein said threaded mounting holes are positioned in dimples in said reinforcement strips providing mechanical stability and accurate positioning of said mounting strips against aforementioned protective sheath during manufacture.

11. The device of claim 8, wherein said reinforcement strips are permanently bonded to aforementioned protective sheath by means of bonding holes which allow the flow through of said protective sheath's materials during manufacture.

12. The device of claim 1, wherein said hydro-reactive barriers are comprised of layered thermally reactive and hydrophilic compounds including super-absorbent polymers and intumescents.

13. The device of claim 1, wherein said hydro-reactive barriers are comprised of granular mixtures of thermally reactive and hydrophilic compounds including super-absorbent polymers and intumescents.

14. Apparatus for protecting data storage media from data loss due to environmental factors comprising:
a multi-piece, mechanically passive, protective assembly of composite materials with low thermal conductivity, highly flame retardant, and zero water absorption properties;
wherein said protective assembly's external dimensions conform to industry standard form factors for internal computer storage devices;
wherein said protective assembly forms a complex partitioned primary internal cavity for housing data storage media;
wherein said protective assembly forms an isolated secondary internal cavity which houses embedded thermal fuses;
wherein electric conductors extend from the primary internal cavity to the thermal fuses embedded within aforementioned secondary internal cavity;
wherein said protective assembly forms an external open cavity of negative depth to house external electrical power and data connections.
wherein said external electrical power and data connections extend internally to the aforementioned thermal fuses within the secondary internal cavity.
wherein said protective assembly forms a complex external open cavity of negative depth to house control circuitry and mechanical devices necessary for operating the storage media contained within the primary internal cavity;
wherein said control circuitry extend internally to the aforementioned thermal fuses within the secondary internal cavity.
wherein said protective assembly provides passageways for thermally resistant components of mechanical devices necessary for operating the storage media contained within the primary internal cavity;
multiple mounting holes positioned around said protective assembly in industry standard locations providing mechanical compatibility with standard retention mechanisms for internal computer storage devices;
a pressure equalizing breather hole providing venting capabilities for the primary internal cavity through said protective assembly;
multiple hydro-reactive barriers providing isolation from water and heated air through which aforementioned thermal fuses and breather hole pass.

15. The apparatus of claim 14, wherein said data storage media includes magnetic hard disk platters, solid-state “flash” memories, optical disks, magnetic tapes, and holographic storage mediums.

16. The apparatus of claim 15, wherein said data storage media is hermetically sealed within the aforementioned primary internal cavity by means of a geometrically interlocking channel.

17. The apparatus of claim 14, wherein said environmental factors include fire and water.

18. The apparatus of claim 14, wherein said composite materials provide low thermal conductivity, high flame retardation, and zero water absorption.

19. The apparatus of claim 14, wherein said industry standard dimensions include industry standard 5.25 inch, slim 5.25 inch, 3.5 inch, 2.5 inch, slim 2.5 inch, and 1.8 inch.

20. The apparatus of claim 14, wherein said thermal fuses are non-resettable electrically conducting devices.

21. The apparatus of claim 14, wherein said industry standard mounting holes are machined with American 6-32 UNC 2B threads and located 3-4 along each length and 4-6 around the bottom perimeter.

22. The apparatus of claim 14, wherein said hydro-reactive barriers are comprised of layered thermally reactive and hydrophilic compounds including super-absorbent polymers and intumescents.

23. The apparatus of claim 14, wherein said hydro-reactive barriers are comprised of granular mixtures of thermally reactive and hydrophilic compounds including super-absorbent polymers and intumescents.

24. The apparatus of claim 14, wherein said mechanical devices necessary for operating the storage media include hard disk drive armatures, hard disk drive spindle motors, optical head assemblies, optical disk head actuator mechanisms, optical disk spindle motors, magnetic tape spindle motors, and magnetic tape guides.

25. The apparatus of claim 24, wherein mechanical surfaces within the aforementioned primary internal cavity are constructed of minimally thermally radiant materials.

26. The apparatus of claim 24, wherein said spindle motors are constructed of materials and components assembled such that heat transfer through the assembly is minimized.

27. The apparatus of claim 26, wherein said spindle motor bearings are constructed fully of ceramic materials.

28. The apparatus of claim 26, wherein said spindle motor's shaft and hat are comprised of fully composite, thermally insulating materials.

29. The apparatus of claim 28, wherein the geometry of said motor hat provides an integrated platter land providing a nonmetallic, thermally insulating support for aforementioned data storage media.

30. The apparatus of claim 26, wherein aforementioned data storage media are physically captured between metallic plater spacers and aforementioned integrated platter land.

31. The apparatus of claim 26, wherein the aforementioned bearings, hat with integrated platter land, data storage media, and platter spacers are physically captured by means of tension between two complementary tensioning plates.

32. The apparatus of claim 26, wherein aforementioned ceramic spindle motor bearings are permanently attached to aforementioned composite spindle motor shaft by means of geometrically complemented fittings and adhesives.

33. The apparatus of claim 24, wherein said mechanical devices are constructed of materials and components assembled such that heat generation and buildup is maintained at levels sufficiently low for operation with zero air flow.

34. The apparatus of claim 24, wherein mechanically active portions of said mechanical devices are mounted to the exterior surface of apparatus of claim 13.
